(19) United States
(12) Patent Application Publication
(10) Pub. No.: US 2026/0105922 A1
(43) Pub. Date: Apr. 16, 2026

(54) REDUNDANT AND SCALABLE AUDIO ENCODING AND TRANSCODING

(71) Applicant: Cisco Technology, Inc., San Jose, CA (US)

(72) Inventors: Mihailo Kolundzija, Lausanne (CH); Christopher Rowen, Santa Cruz, CA (US); Mathew Shaji Kavalekalam, Warsaw (PL); Piotr B. Rozen, Gdansk (PL); Ivana M. Balic, Studen (CH)

(21) Appl. No.: 18/911,615

(22) Filed: Oct. 10, 2024

(51) Int. Cl. G10L 19/002; H04L 65/70

(52) U.S. Cl. CPC G10L 19/002; H04L 65/70

(57) ABSTRACT

A method performed by an audio transcoder comprises: receiving a mixed-bitrate encoded audio packet that includes encoding vectors representative of a quantized current audio frame and quantized past audio frames, wherein the encoding vectors include a current high-bitrate encoding vector having a high encoding bitrate and past low-bitrate encoding vectors having low encoding bitrates that are less than the high encoding bitrate; selecting a subset of the encoding vectors; repacketizing the subset of the encoding vectors into a transcoded audio packet that has different encoding bitrates from the mixed-bitrate encoded audio packet; and transmitting the transcoded audio packet over a network link.

### TECHNICAL FIELD

The present disclosure relates generally to audio encoding and transcoding.

### BACKGROUND

Conferencing with heterogeneous clients can be challenging. Heterogeneous clients have disparate capabilities with respect to handling audio encoded at different bitrates. Ideally, conferencing should meet high audio (and video) quality expectations of clients operating under good network conditions. At the same time, clients with limited bandwidth can be less demanding with respect to media quality and are better served by encoding audio with low or moderate bitrates. Also, clients experiencing network losses benefit from using network resilience mechanisms, which typically include some form of redundancy. Finally, media delivery with network and client adaptation mechanisms is often preferred for working transparently and efficiently with additional features, such as end-to-end encryption. Conventional audio encoding and transcoding techniques lack the capability and flexibility to meet the aforementioned combination of expectations and challenges.

### BRIEF DESCRIPTION OF THE DRAWINGS

FIG. 1 shows an audio encoder-decoder (codec) system in which redundant audio encoding and transmission techniques may be implemented, according to an example embodiment.

FIG. 2 is a block diagram of a mixed-bitrate (MB) encoder, according to an example embodiment.

FIG. 3 is a block diagram of a multistage vector quantizer of the MB encoder that performs residual vector quantization (VQ) to quantize an audio frame into an encoding vector, according to an example embodiment.

FIG. 4 shows encoding vectors that having different bitrates produced by the MB encoder, according to an example embodiment.

FIG. 5 shows a block diagram of a control signal generator of the MB encoder, according to an example embodiment.

FIG. 6 shows example selections of encoding vectors and packetization of the same into encoded audio packets based on control signal values representative of link parameters, according to an example embodiment.

FIG. 7 is a block diagram of an audio encoder, according to an example embodiment.

FIG. 8 is a block diagram of another audio encoder, according to an example embodiment.

FIG. 9 is a block diagram of an audio transcoder of the codec system and that performs transcoding (e.g., repacketizing) of an encoded audio packet, according to an example embodiment.

FIG. 10 is an illustration of repacketizing an encoded audio packet into transcoded audio packets performed by the audio transcoder, according to an example embodiment.

FIG. 11 is an illustration of a network environment in which media servers selectively transcode (e.g., repacketize) encoded audio packets, according to an example embodiment.

FIG. 12 is a block diagram of an audio decoder of the codec system and that employs a single decoder, according to an example embodiment.

FIG. 13 is a block diagram of an audio decoder that employs multiple decoders, according to an example embodiment.

FIG. 14 is a flowchart of a method of encoding audio performed by the MB encoder, according to an example embodiment.

FIG. 15 is a flowchart of a method expanding on the method of FIG. 14, according to an example embodiment.

FIG. 16 is a flowchart of a method of transcoding (e.g., repacketizing) an encoded audio packet performed by the audio transcoder, according to an example embodiment.

FIG. 17 illustrates a hardware block diagram of a computing device that may perform functions associated with operations discussed herein, according to an example embodiment.

### DETAILED DESCRIPTION

### Overview

In an embodiment, a method is performed by an audio encoder. The method comprises: quantizing a current audio frame and past audio frames into high-bitrate encoding vectors to include a current high-bitrate encoding vector and past high-bitrate encoding vectors that each have a high encoding bitrate; reducing the high encoding bitrate of the past high-bitrate encoding vectors to low encoding bitrates that are less than the high encoding bitrate, to produce past low-bitrate encoding vectors that have the low encoding bitrates; selecting one or more of the current high-bitrate encoding vector or the past low-bitrate encoding vectors, to produce one or more selected encoding vectors; creating an encoded audio packet to include the one or more selected encoding vectors; and transmitting the encoded audio packet to a network.

In another embodiment, a method is performed by an audio transcoder. The method comprises: receiving a mixed-bitrate encoded audio packet that includes encoding vectors representative of a quantized current audio frame and quantized past audio frames, wherein the encoding vectors include a current high-bitrate encoding vector having a high encoding bitrate and past low-bitrate encoding vectors having low encoding bitrates that are less than the high encoding bitrate; selecting a subset of the encoding vectors; repacketizing the subset of the encoding vectors into a transcoded audio packet that has different encoding bitrates from the mixed-bitrate encoded audio packet; and transmitting the transcoded audio packet over a network link.

### Example Embodiments

Embodiments presented herein improve audio network resilience at high packet-loss rates, and deliver good audio quality over bandwidth-limited channels. To that end, the embodiments include audio encoding, packetization, repacketization (e.g., transcoding), and decoding techniques (collectively referred to as “redundant audio encoding and transmission techniques”), which offer bandwidth efficiency while providing the flexibility to meet the expectations, and overcome the challenges, mentioned above. The embodiments provide a low-cost processing burden to media switching and transcoding servers. Furthermore, the embodiments may be implemented in/with a neural speech and audio encoder-decoder (codec), and bitrate-scalable encoding techniques employed by the codec. Without loss of generality, such codecs may be referred to as “scalable codecs.” As used herein, a “coder” and “coding” are also referred to as an “encoder” and “encoding.”

The redundant audio encoding and transmission techniques provide error resilience to high packet-loss rates, simple bandwidth adaptation, redundancy on demand, and scalable audio delivery normally achieved through multiple audio streams. The redundant audio encoding and transmission techniques are compatible with end-to-end encryption and have relatively low overhead. Unless stated otherwise, the term “bitrate” as used herein means “encoding bitrate,” i.e., a bitrate at which an encoder encodes audio. This is not to be confused with “transmission bitrate,” which is a bitrate at which information/data is transmitted (or received) over a network link (referred to simply as a “link”). The ensuing description may use the terms “bitrate” and “encoding bitrate” interchangeably.”

The redundant audio encoding and transmission techniques can deliver, for example, a high-definition, high-bitrate (HB) audio stream in a standard audio transmission format, a low-definition, low-bitrate (LB) audio stream in a standard audio transmission format, a high-definition, HB audio stream with redundancy for packet-loss resilience when supported by a client, and a low-definition, LB audio stream with redundancy for packet-loss resilience when supported by the client.

The redundant audio encoding and transmission techniques include, but are not limited to, the following features. First, redundant audio encoding using audio encoders that encode audio at different bitrates, which may include a mixed-bitrate (MB) encoder, or one encoder that employs a scalable encoding technique. The different bitrates include a high bitrate and low bitrates. Second, redundant audio packetization, including packetizing (of current and past) HB and LB encoding vectors (described below) into an encoded audio packet (also referred to as a “network packet”) for transmission over a network. Third, repacketization (e.g., transcoding) and forwarding of redundant encoded audio packets for delivery to heterogeneous clients. Fourth, decoding of received encoded audio packets.

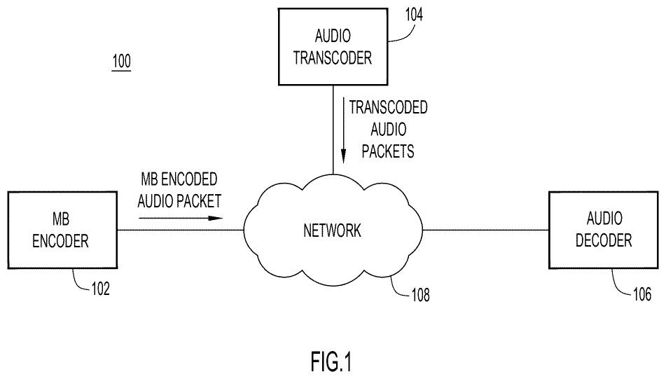

FIG. 1 shows an example audio codec system 100 in which the redundant audio encoding and transmission techniques may be implemented. Audio codec system 100 includes a mixed-bitrate (MB) encoder 102, an audio transcoder 104, and an audio decoder 106 connected to, and configured to communicate with each other over, a network 108. Network 108 may include one or more wide area networks (WANs), such as the Internet, and one or more local area networks (LANs), for example. In an example, MB encoder 102, audio transcoder 104, and audio decoder 106 may reside in physically separate client devices (also referred to as “endpoint devices” or simply “clients”). In another example, two or more of the foregoing components may reside in the same client. MB encoder 102, audio transcoder 104, and audio decoder 106 exchange encoded audio packets with network 108 using any known or hereafter developed communication protocols, such as the Transmission Control Protocol (TCP)/Internet Protocol (IP), and the like.

At a high level, MB encoder 102 generates an encoded audio packet to include audio encoded at different or mixed bitrates, and transmits the encoded audio packet to audio transcoder 104 over network 108. Audio transcoder 104 transcodes the encoded audio packet into one or more new encoded audio packets (also referred to as “transcoded audio packets”) that may or may not have mixed bitrates, and forwards the same to audio decoder 106 and to other clients (not shown). In another example in which audio transcoder 104 is bypassed, MB encoder 102 may send the encoded audio packet directly to audio decoder 106 and the other clients. MB encoder 102 encodes audio at different bitrates according to (e.g., matched or mapped to) different desired audio qualities, different client capabilities, and link parameters. For example, MB encoder 102 may encode audio at a high bitrate defined by desired high audio quality in normal operating conditions and when clients have sufficient receive bandwidth to accommodate or handle the high bitrate. In contrast, MB encoder 102 may encode audio at a low bitrate defined by what is deemed fallback audio quality when network conditions are compromised.

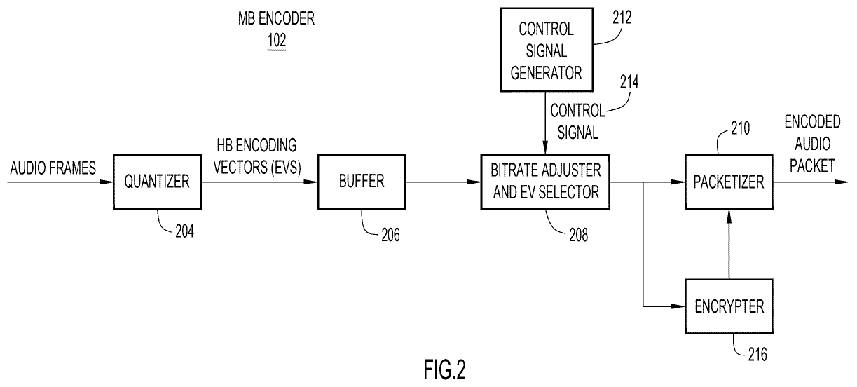

FIG. 2 is a block diagram of MB encoder 102 according to an embodiment. MB encoder 102 includes a quantizer 204, a buffer 206, a bitrate adjuster and encoding vector (EV) selector 208, a packetizer 210, and a control signal generator 212. Quantizer 204 receives a sequence of audio frames that include a most recent or current audio frame and previous or past audio frames. Quantizer 204 quantizes the audio frames into corresponding ones of HB encoding vectors (one per audio frame) including a current HB encoding vector and past HB encoding vectors, that each have a high bitrate. Quantizer 204 stores the HB encoding vectors into buffer 206 as a block of HB encoding vectors.

Responsive to a control signal 214 generated by control signal generator 212, bitrate adjuster and EV selector 208 reduces the high bitrate of each of the past HB encoding vectors to produce corresponding ones of past LB encoding vectors that have low bitrates that are each less than the high bitrate. As an option, bitrate adjuster and EV selector 208 also copies the current HB encoding vector and reduces the high bitrate of the copy to produce a current LB encoding vector that has a low bitrate that is less than the high bitrate. After the foregoing HB encoding vector manipulations, buffer 206 retains the current HB encoding vector, optionally the current LB encoding vector, and the past LB encoding vectors. In response to control signal 214, bitrate adjuster and EV selector 208 tags or selects one or more of the current HB encoding vector, the current LB encoding vector, and the past LB encoding vectors, to produce one or more selected encoding vectors.

Packetizer 210 copies the one or more selected encoding vectors and appends a header to the copied encoding vectors to create an encoded audio packet. In an example, the header includes all or a subset of the following parameters: a payload type (which may identify an encoding standard used to encode the audio frames); packet sequence numbers; timestamps; and different payload offsets and sizes. The header may include other types of data, such as source identifiers, volume indicators, voice activity indicators, and so on, for example. The header may further include network information, such as an IP header, for example. Packetizer 210 transmits the encoded audio packet to network 108 over a link, at a transmission bitrate that the link can accommodate. In this way, packetizer 210 packetizes the selected encoding vectors into the encoded audio packet along with the header, and transmits the resulting encoded audio packet.

MB encoder 102 employs a packetization scheme that allows sending of the encoded audio packet with a desired level of redundancy (in resolution and in time) for packet resilience and flexible and scalable delivery. To this end, MB encoder 102 can selectively/optionally packetize only HB encoding vectors (e.g., one or more HB encoding vectors) into the encoded audio packet, only LB encoding vectors (e.g., one or more LB encoding vectors) into the encoded audio packet, or both HB and LB encoding vectors into the encoded packet. As used herein, the terms “HB packet,” “LB packet,” and “MB packet” respectively refer to an encoded audio packet that includes only HB encoding vectors (e.g., one or more HB encoding vectors), only LB encoding vectors (e.g., one or more LB encoding vectors), and both HB and LB encoding vectors.

In an encryption embodiment, MB encoder 102 also includes an encryptor 216. Encryptor 216 independently encrypts each of the current HB encoding vector, the current LB encoding vector, and the set of past LB encoding vectors to produce independently encrypted encoding vectors, including an encrypted current HB encoding vector, an encrypted current LB encoding vector, and an encrypted set of past LB encoding vectors. The independently encrypted encoding vectors may each be decrypted independently. In an example, encryptor 216 may use different encryption keys to encrypt corresponding ones of the current HB encoding vector, the current LB encoding vector, and the set of past LB encoding vectors. In the encryption embodiment, packetizer 210 packetize some or all of the encrypted encoding vectors into the encoded audio packet.

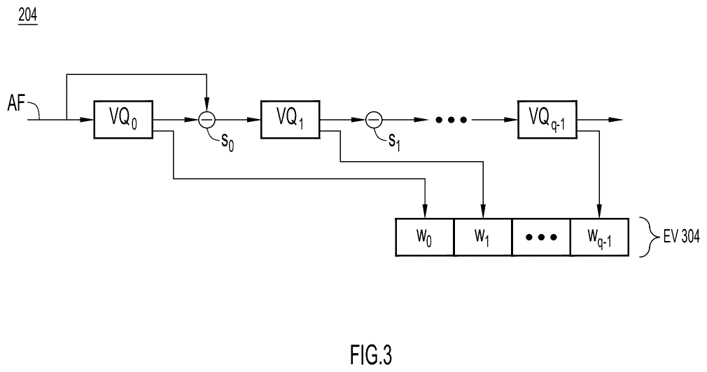

The term “scalable audio codec” used herein refers to both a traditional and a deep neural network-based (also referred to as a “neural-based”) audio codec, which may both employ residual vector quantization (VQ) of audio frames, and which are scalable by design. Other VQ variations scalable by design, such as product VQ and additive VQ, can also be used. FIG. 3 is a block diagram of quantizer 204 implemented as a multistage vector quantizer that performs residual VQ to quantize an audio frame AF (or a processed version of the audio frame, such as an embedding vector) into an encoding vector 304, according to an embodiment. The encoding vector may also be referred to as a “quantized audio frame” and a “frame encoding.”

The multistage vector quantizer includes residual VQ blocks VQ₀, VQ₁, . . . , VQ_{q-1} and subtractors S₀, S₁, etc., alternated with the residual VQ blocks. The residual VQ blocks and subtractors sequentially quantize audio frame AF into encoding vector 304. Encoding vector 304 includes q codewords w₀, w₁, . . . , w_{q-1} selected from respective codebooks of residual VQ stages VQ₀, VQ₁, . . . , VQ_{q-1}. The VQ produces (one) encoding vector 304 per audio frame (i.e., the process quantizes each audio frame into a corresponding encoding vector). Codewords w₀, w₁, . . . , w_{q-1} of encoding vector 304 may represent codebook indices (also referred to as “codeword indices” or simply “indices”). Generally, MB encoder 102 transmits each encoding vector (which represents a corresponding audio frame) in the form of its codeword indices.

Encoding vector 304 has a length=q, meaning that the encoding vector includes q codewords/indices. Upon transmission of encoding vector 304, the (encoding) bitrate of the encoding vector corresponds, and varies in proportion, to its length q. More generally, an encoding vector of q codewords/indices has a higher bitrate than an encoding vector of m<q codewords/indices. Therefore, reducing the number of codewords/indices of the encoding vector prior to its transmission reduces the bitrate of the encoding vector.

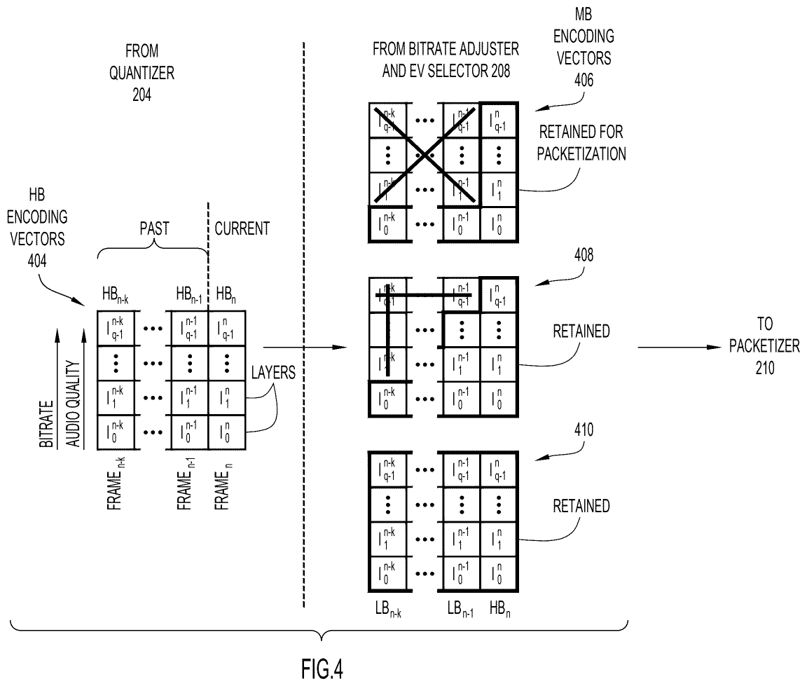

Various examples described below reduce the bitrate by sending a subset of m codewords/indices (e.g., w₀, w₁, . . . , wₘ₋₁) in place of a full encoding vector of q codewords/indices (e.g., w₀, w₁, . . . , w_{q-1}). In the ensuing description, the codewords/indices of an encoding vector may be referred as elements or layers of the encoding vector. That is, an encoding vector of length q includes q layers. The examples described below vary the bitrate by retaining different numbers of consecutive layers starting from the lowest layer. FIG. 4 described below shows example encoding vectors having different bitrates that are obtained using such a process.

FIG. 4 shows example encoding vectors produced by quantizer 204 (e.g., by the multistage vector quantizer) and then selected by bitrate adjuster and EV selector 208. Quantizer 204 quantizes a sequence of (k+1) audio frames into a sequence of (k+1) HB encoding vectors 404 (where each vector includes a set of codeword indices), and stores the same in buffer 206 (not shown). More specifically, quantizer 204 quantizes a current audio frame frameₙ and past audio frames frameₙ₋₁, . . . , frameₙ₋ₖ into corresponding ones of HB encoding vectors 404 that include a current HB encoding vector HBₙ and past HB encoding vectors HBₙ₋₁, . . . , HBₙ₋ₖ. Each HB encoding vector is represented as a layered column vector of q layers (i.e., q codeword indices lₐ^{b}, defined below) corresponding to a high bitrate. That is, each HB encoding vector has a (column) length=q. Thus, the (k+1) HB encoding vectors 404 form a (k+1)·q cell rectangle, which represents a full (e.g., high bitrate) representation of (k+1) consecutive encoding vectors for (k+1) consecutive audio frames.

Each layer of an encoding vector is denoted lₐ^{b}, where subscript “a” represents an index of a layer (e.g., 0 to q−1) and superscript “b” represents a time-ordered frame position or index of the encoding vector (where n is the most recent or current and n-k is the oldest having the greatest time offset from the current). The addition of layers in the column of an encoding vector starting with index 0 increases the bitrate and audio quality, while reducing the layers starting with q−1 decreases the bitrate and audio quality. Therefore, varying the bitrate can be achieved by retaining different numbers of consecutive layers.

Bitrate adjuster and EV selector 208 accesses the HB encoding vectors 404 from buffer 206. In response to control signal 214, bitrate adjuster and EV selector 208 may transform HB encoding vectors 404 to MB encoding vectors to be passed to packetizer 210 as “selected” encoding vectors for packetization into an encoded audio packet. FIG. 4 shows two such transformation examples, but many others are possible. In a first example, bitrate adjuster and EV selector 208 reduces the high bitrate of past HB encoding vectors HBₙ₋₁, . . . , HBₙ₋ₖ by removing all but one layer from each past HB encoding vector, to produce MB encoding vectors 406. MB encoding vectors 406 include current HB encoding vector HBₙ that has the high bitrate and past LB encoding vectors LBₙ₋₁, . . . , LBₙ₋ₖ that each have a low bitrate that is less than the high bitrate. In FIG. 4, the MB encoding vectors (and their layers) that are retained/selected for packetization are shown enclosed by a bolded outline, and the MB encoding vectors that are not retained are shown with the large “X” through them in MB encoding vectors 406 and horizontal and vertical strikethrough bars through them in MB encoding vectors 408. In a variation (not shown), bitrate adjuster and EV selector 208 copies current HB encoding vector HBₙ to produce a copy thereof, reduces the bitrate of the copy to produce a current LB encoding vector LBₙ, and inserts the same between the current HB encoding vector HBₙ and past LB encoding vectors LBₙ₋₁, . . . , LBₙ₋ₖ, to create a set of MB encoding vectors including HBₙ, LBₙ, LBₙ₋₁, . . . , LBₙ₋ₖ (not specifically shown).

In a second example, bitrate adjuster and EV selector 208 incrementally reduces the high bitrate of past HB encoding vectors HBₙ₋₁, . . . , HBₙ₋ₖ, by reducing the number of layers in the past HB encoding vectors incrementally as their time offsets from the current (most recent) HB encoding vector increase incrementally, to produce MB encoding vectors 408. MB encoding vectors 408 include current encoding vector HBₙ and past LB encoding vectors LBₙ₋₁, . . . , LBₙ₋ₖ. The past LB encoding vectors have low bitrates that vary across the LB encoding vectors so as to resemble a staircase that falls as the time offsets increase between the current HB encoding vector and the past LB encoding vectors.

More generally, the first and second examples described above may be thought of as packetizing current HB encoding vector HBₙ together with k past LB encoding vectors LBₙ₋₁, . . . , LBₙ₋ₖ in different ways, which is equivalent to selecting different subsets of the (k+1)·q cell rectangle of HB encoding vectors 404. In a third example, bitrate adjuster and EV selector 208 simply passes all HB encoding vectors 404 to packetizer 210, as HB encoding vectors 410.

In another example, in response to control signal 214, bitrate adjuster and EV selector 208 may select less than the k+1 encoding vectors in buffer 206 for transmission. For example, assuming that buffer 206 stores 20 encoding vectors for 20 audio frames, bitrate adjuster and EV selector 208 may select only the 10 most recent encoding vectors for transmission. This adds another dimension of flexibility in packetizing the encoding vectors stored in buffer 206.

Returning to FIG. 2, control signal generator 212 may generate control signal 214 to control bitrate reduction and selection of encoding vectors by bitrate adjuster and EV selector 208 based on different criteria. In a link-parameter example described below, control signal generator 212 generates control signal 214 based on link parameters that characterize a link over which the encoded audio packet is to be transmitted. The link parameters may be indicative of an audio quality that the link can support. In another example, control signal generator 212 generates control signal 214 according to a predetermined scheme, identities of clients for which the encoded audio packet is destined, and so on. There are many other criteria under which control signal generator 212 may generate control signal 214.

In the link-parameter example, control signal generator 212 determines link parameters that characterize the link, and generates control signal 214 based on the link parameters so that bitrate adjuster and EV selector 208 selects encoding vectors with bitrates based on (i.e., in accordance) with the link parameters. The link parameters may also characterize a decoding capability of a client for which the audio packet is intended. The link parameters may include a bandwidth of the link (which may, in some cases, be considered equivalent to a transmission bitrate supported by the link), a packet-loss rate on the link, a length of time (which may be an average) over which a burst of consecutive packets are lost on the link (also referred to as a packet-loss burst length), a bit error rate (BER), and a decoding bitrate supported by the client, for example. As used herein, the “term” bandwidth is defined broadly to cover a bandwidth of the link, a transmission bitrate, and a decoding bitrate of a client.

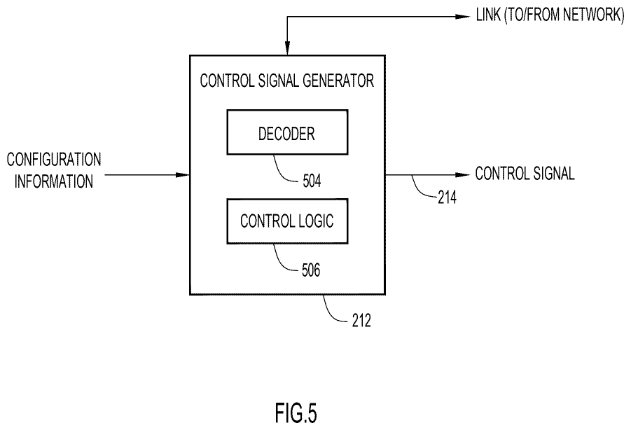

FIG. 5 shows a block diagram of control signal generator 212. Control signal generator 212 is coupled to a bidirectional link (referred to simply as a “link”) monitored by the control signal generator. MB encoder 102 may transmit encoded audio packets on the link, and control signal generator 212 may receive encoded audio packets from the link for the purpose of deriving link parameter measurements. Control signal generator 212 may determine/measure a bandwidth (e.g., a transmission bitrate) of the link. Control signal generator 212 may include a decoder 504 to decode encoded audio packets on the link and to measure a packet-loss rate. Control signal generator 212 may also receive configuration information that includes a decoding capability of a client (when available) and other preconfigured link parameters. Control signal generator 212 includes control logic 506 to generate control signal 214 to reflect the aforementioned link parameters. For example, control logic 506 assigns a control signal value to control signal 214 that reflects a particular set of link parameter values for bandwidth, packet-loss rate, and so on.

Continuing with the link-parameter example, the control signal values may indicate whether the bandwidth is a high bandwidth (HBW) or a low bandwidth (LBW) that is less than the high bandwidth, and whether the packet-loss rate is a high-loss (HL) rate or a low-loss (LL) rate that is less than the high-loss rate. Control signal generator 212 may determine that the bandwidth is the high bandwidth or the low bandwidth when the bandwidth exceeds a threshold or is below a threshold, respectively. Similarly, control signal generator 212 may determine that the packet-loss rate is the LL rate or the HL rate when the packet-loss rate exceeds a threshold or is below a threshold, respectively.

Possible control signal values hb, lb, hbr, and lbr may be mapped to link parameter tuples as shown by way of example in Table 1 below.

TABLE 1

| Link Parameter Tuple for Link | Control Signal Value |
|---|---|
| high bandwidth:low-loss rate [HBW:LL] | hb |
| low bandwidth:low-loss rate [LBW:LL] | lb |
| high bandwidth:high-loss rate [HBW:HL] | hbr |
| low bandwidth:high-loss rate [LBW:HL] | lbr |

In another example, the above two-tuple may extended to include the packet-loss burst length, as mentioned above.

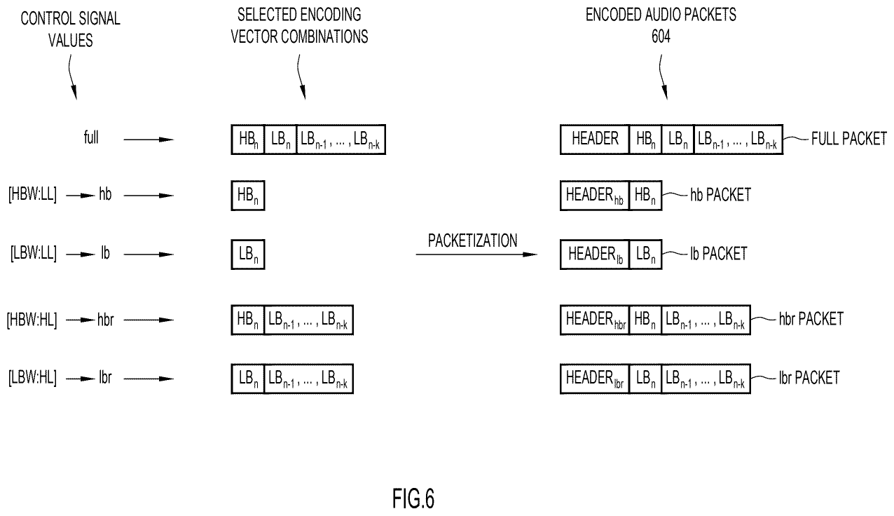

Responsive to the control signal values, bitrate adjuster and EV selector 208 selects different combinations of encoding vectors as shown in FIG. 6. FIG. 6 shows example selections of encoding vectors and packetization of the same into encoded audio packets based on control signal values mapped to the link parameters. As shown in FIG. 6, responsive to control signal values full, hb, lb, hbr, and lbr, bitrate adjuster and EV selector 208 respectively selects the combinations of encoding vectors (HBₙ, LBₙ, LBₙ₋₁, . . . , LBₙ₋ₖ), (HBₙ), (LBₙ), (HBₙ, LBₙ₋₁, . . . , LBₙ₋ₖ), and (LBₙ, LBₙ₋₁, . . . , LBₙ₋ₖ). The control signal value “full” selects all possible encoding vectors for packetization and may or may not be part of link parameter selection control as described herein. In an example in which the link parameters further include a packet-loss burst length, the control values can be extended to increase or decrease the selected number of past LB encoding vectors in correspondence with an increase or decrease with packet-loss burst length, respectively.

Packetizer 210 appends matching headers to respective ones of the selected combinations of encoding vectors to produce encoded audio packets 604 to include a full packet (which is an MB packet), an hb packet (which is an HB packet), an lb packet (which is an LB packet), an hbr packet (which is an MB packet), and an lbr packet (which is an LB packet), as shown on the right-hand side of FIG. 6.

FIG. 6 represents an example redundant audio packetization technique that produces a range of encoded audio packets having different mixes of bitrates for use in a corresponding range of circumstances. The full packet includes encoding vectors that cover all of the bitrate possibilities. Moreover, the components of the full packet, including (i) current HB encoding vector HBₙ, (ii) current LB encoding vector LBₙ, and (iii) past encoding vectors LBₙ₋₁, . . . , LBₙ₋ₖ, may be encrypted separately, as described above. The hbr packet may be used with clients that support the redundant audio packetization technique or only a standard packetized audio stream. On the other hand, the lbr packet allows for redundant and scalable encoded audio delivery to clients over links with a high bandwidth or a low bandwidth and that have a high packet-loss rate or a low packet-loss rate.

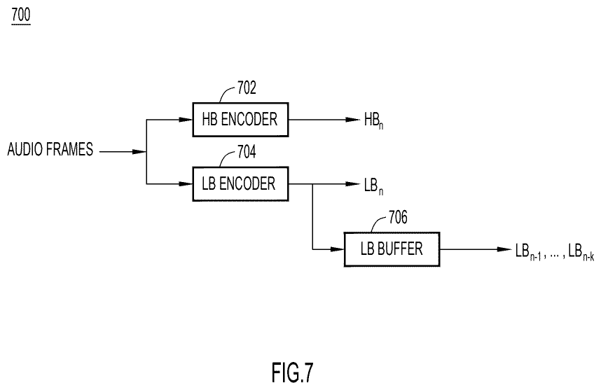

FIG. 7 is a block diagram of an example audio encoder 700. Audio encoder 700 includes two encoder instances that are compliant with the same audio coding standard, but that encode at different bitrates. The two encoder instances include an HB encoder 702 and an LB encoder 704. HB encoder 702 encodes a current audio frame of a block of audio frames into a current HB encoding vector HBₙ. In parallel, LB encoder 704 encodes the current audio frame into a current LB encoding vector LBₙ. Audio encoder 700 includes an LB buffer 706 fed by LB encoder 704 and configured to produce, over time, past LB encoding vectors LBₙ₋₁, . . . , LBₙ₋ₖ representative of past audio frames. All of the LB encoding vectors have lower bitrates than the current HB encoding vector. The lower bitrates may be variable. The lower bitrates of the past LB encoding vectors may decrease in correspondence with an increase in time offsets between the current HB encoding vector and the past LB encoding vectors. The aforementioned encoding vectors may be packetized into encoded audio packets according to the capability of a decoder at a receiving client.

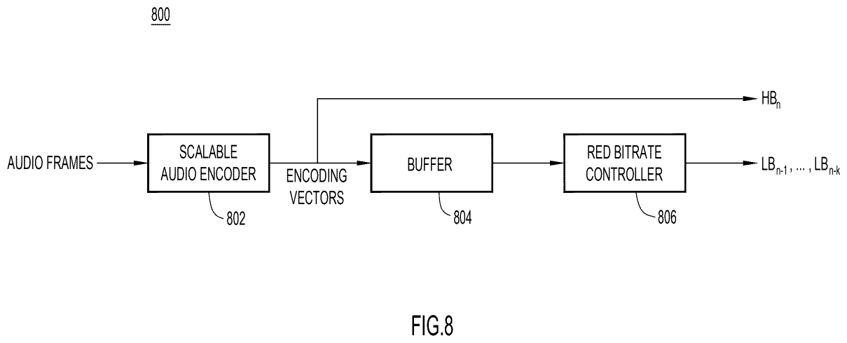

FIG. 8 is a block diagram of an example audio encoder 800. Audio encoder 800 includes a scalable audio encoder 802, a buffer 804, and a redundant (RED) bitrate controller 806. Scalable audio encoder 802 encodes a current audio frame into a current HB encoding vector HBₙ, and supplies the same to buffer 804. In turn, RED bitrate controller 806 reduces layers (and thus bitrates) of past HB encoding vectors to produce past LB encoding vectors LBₙ₋₁, . . . , LBₙ₋ₖ. RED bitrate controller 806 may modify the bitrates of the past HB encoding vectors based on their time offset relative to the current HB encoding vector at time instant n.

Audio transcoding techniques are now described. A traditional audio transcoder decodes audio to produce decoded audio and then recodes the decoded audio to effect a change in bitrate. At a high level, audio transcoder 104 performs repacketization of encoding vectors in the encoded audio packet to effect the change in bitrate, without the decoding and recoding. More specifically, audio transcoder 104 removes a payload of the encoded audio packet that includes the encoding vectors, shuffles the encoding vectors (which includes removing one or more of the encoding vectors), recomputes a header to reflect the change, and packetizes the result into a transcoded audio packet. The information contained in the initial header is sufficient to perform the shuffle without modifying the encoding vectors, which is advantageous when the encoding vectors are encrypted.

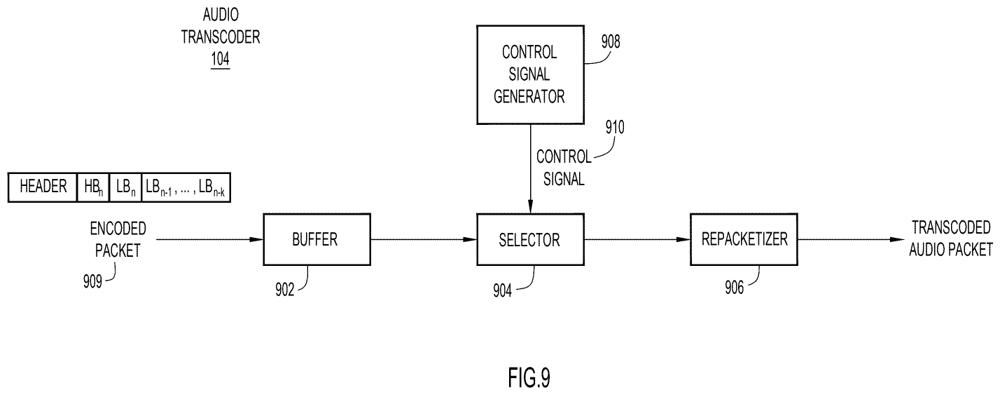

FIG. 9 is a block diagram of audio transcoder 104 that performs transcoding, according to an embodiment. Audio transcoder 104 includes a buffer 902, a selector 904, a repacketizer 906, and a control signal generator 908. Buffer 902 receives from network 108 an encoded audio packet 909 to be transcoded, and stores the encoded audio packet. Encoded audio packet 909 includes a full set of current, past, and redundant encoding vectors to include current HB encoding vector HBₙ, current LB encoding vector LBₙ, and past LB encoding vectors LBₙ₋₁, . . . , LBₙ₋ₖ, as described above. Audio transcoder 104 transcodes (i.e., repacketizes) encoded audio packet 909 into a transcoded audio packet (also referred to as “new encoded audio packet”) for transmission. More specifically, audio transcoder 104 transcodes encoded audio packet 909 by repacketizing (i.e., performing repacketization of) the encoding vectors of the encoded audio packet, as described below. The new encoded audio packet is referred to as a “transcoded” audio packet because its encoding bitrates differ from those of encoded audio packet 909.

Responsive to a control signal 910 generated by control signal generator 908, selector 904 tags/selects one or more of the encoding vectors in encoded audio packet 909. For example, selector 904 selects a subset (i.e., one or more, but less than all) of the encoding vectors. Control signal generator 908 and control signal 910 may be configured similarly to control signal generator 212 and control signal 214, described above. Control signal generator 908 may generate control signal 910 to have a control signal value among multiple possible control signal values that select corresponding ones of multiple (different) subsets of the encoding vectors. Repacketizer 906 repacketizes the subset of encoding vectors into a transcoded audio packet, in the following manner. Repacketizer 906 computes a new header based on the encoding vector(s) of the subset, i.e., to reflect the change in encoding vectors from encoded audio packet 909 to the subset. Repacketizer 906 copies the new header and the subset of encoding vectors from buffer 902 into the transcoded audio packet. The transcoded audio packet may be formatted as a network packet. Repacketizer 906 transmits the transcoded audio packet to network 108. Audio transcoder 104 can optionally operate in a pass-through mode that simply passes encoded audio packet 909 to network 108 in response to control signal 910.

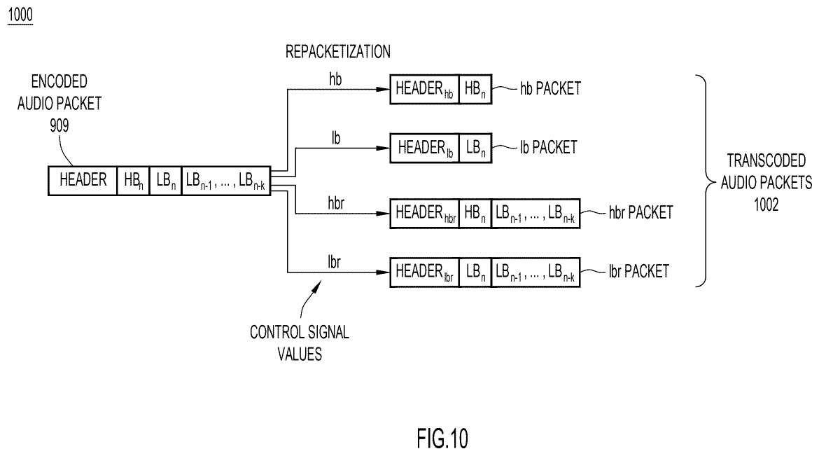

FIG. 10 is an illustration of example repacketization 1000 of encoded audio packet 909 into transcoded audio packets 1002 (e.g., new encoded audio packets) performed by audio transcoder 104. Audio transcoder 104 repacketizes encoded audio packet 909 into transcoded audio packets 1002 including an hb packet, an lb packet, an hbr packet, and an lbr packet responsive to control signal values hb, lb, hbr, and lbr, respectively, as shown. Each transcoded audio packet includes only a subset of the encoding vectors of encoded audio packet 909, as shown in FIG. 9. As mentioned above, audio transcoder 104 can also pass encoded audio packet 909 without transcoding in response to a control signal value=full (not shown).

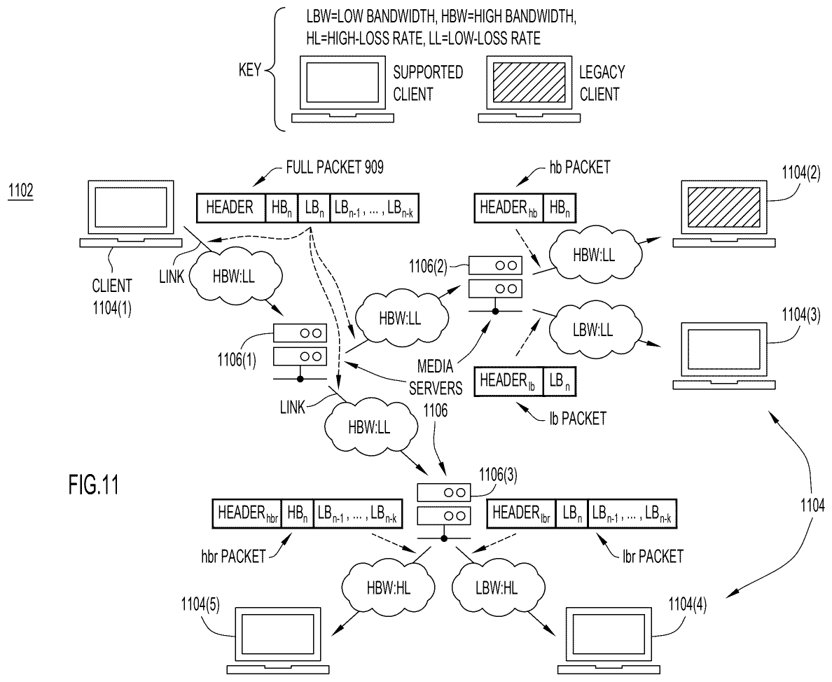

Network 108 may include distributed media servers that include instances of MB encoder 102 and audio transcoder 104 and are connected to clients over various network links. Some clients may support redundant packetization techniques described herein, and others may not. For example, some of the clients may have bandwidth capabilities that are reduced due to network constraints, or due to limitations of the clients themselves, such as with legacy clients. To support the range of clients, the media servers can transcode (e.g., repacketize) redundant encoded audio packets received by the media serves to produce transcoded audio packets compatible with transmission to the clients. Encoded audio streams forwarded from the media servers to the clients may include only HB packets, only LB packets, or MB packets, depending on the client capabilities and the links leading to the clients, as described below in connection with FIG. 11.

FIG. 11 is an illustration of a network environment 1102 in which embodiments directed to transcoding (e.g., repacketizing) of encoded audio packets may be implemented. Network environment 1102 includes clients 1104(1)-1104(5) (collectively referred to as “clients 1104”) and media servers 1106(1)-1106(3) (collectively referred to as “media servers 1106”) that communicate with each other over respective links (also referred to as “access channels”) of a network (e.g., network 108). Clients 1104 are heterogenous meaning that some clients support the encoding and transcoding techniques presented herein, while others (e.g., legacy client 1104(2)) do not. Clients 1104(2)-1104(5) include decoders that may have different decoding capabilities, as described above. The links having different combinations of link parameters from low to high bandwidth and low to high packet-loss rates, as indicated in FIG. 11.

Client 1104(1) generates an encoded audio packet that includes the full set of encoding vectors described above, and transmits the same to media server 1106(1) over a [HBW: LL] link, i.e., without down selecting the encoding vectors of the encoded audio packet. In turn, media server 1106(1) forwards the encoded audio packet (or copies of the same) to media servers 1106(2) and 1106(3) over respective [HBW: LL], without repacketization.

Media server 1106(2) has [HBW: LL], [LBW: LL] links to clients 1104(2), 1104(3), respectively. Media server 1106(2) repacketizes the encoded audio packet into an hb packet for the [HBW: LL] link and forwards the hb packet to client 1104(2). Media server 1106(2) repacketizes the encoded audio packet into an lb packet for the [LBW: LL] link and forwards the lb packet to client 1104(3).

Media server 1106(3) has [LBW: HL], [HBW: HL] links to clients 1104(4), 1104(5), respectively. Media server 1106(3) repacketizes the encoded audio packet into an lbr packet for the [LBW: HL] link and forwards the lbr packet to client 1104(4). Media server 1106(3) repacketizes the encoded audio packet into an hbr packet for the [HBW: HL] link and forwards the hbr packet to client 1104(5).

Audio decoders for decoding encoded audio packets are now described. Ideally, an audio decoder seamlessly decodes an audio stream that includes any combination of MB, HB, and LB packets. Generally, audio decoders that form part of conventional or neural-based audio codecs can support such decoding.

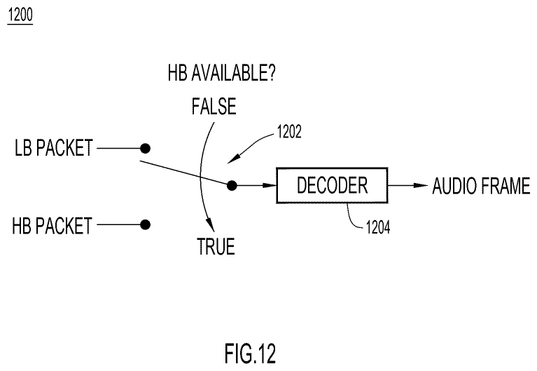

FIG. 12 is a block diagram of an example audio decoder 1200 that employs a single audio decoder. Audio decoder 1200 includes a selector 1202 (also referred to as a “playout buffer”) followed by an audio decoder 1204 (which is the single audio decoder) capable of decoding an HB packet and an LB packet. For a given packet sequence number in a received stream of encoded audio packets, selector 1202 feeds an HB packet (selector position=True) or an LB packet (selector position=False) to audio decoder 1204, which decodes the forwarded encoded audio packet into an audio frame. When neither the HB packet nor the LB packet is available (e.g., a missing encoded frame has occurred), audio decoder 1204 resorts to packet-loss concealment (PLC).

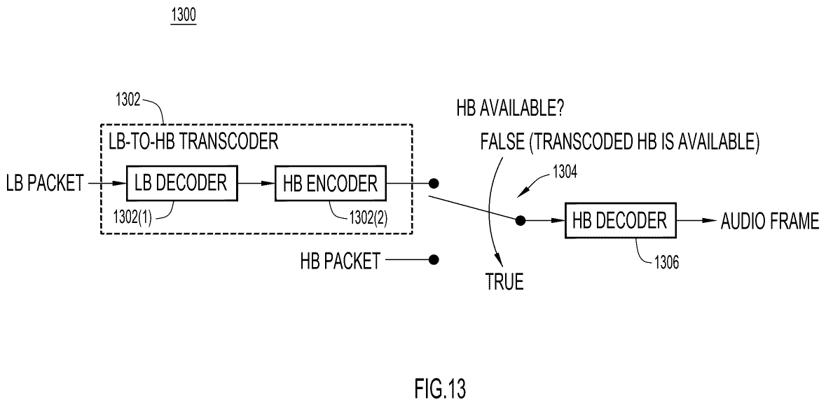

FIG. 13 is a block diagram of an example audio decoder 1300 that employs multiple audio decoders. Audio decoder 1300 include an LB-to-HB transcoder 1302 equipped with an LB decoder 1302(1) followed by an HB encoder 1302(2), which operate together to transcode an LB packet to a transcoded HB packet. Audio decoder 1300 further incudes a selector 1304 and an HB decoder 1306. Upon arrival of an LB packet, LB-to-HB transcoder 1302 transcodes the LB packet to a transcoded HB packet, and provides the same to a first input of selector 1304. Upon arrival of an HB packet, the HB packet is fed to a second input of selector 1304. Selector 1304 forwards whichever one of the transcoded HB packet or the HB packet is available to HB decoder 1306, which decodes the forwarded encoded audio packet to produce an audio frame.

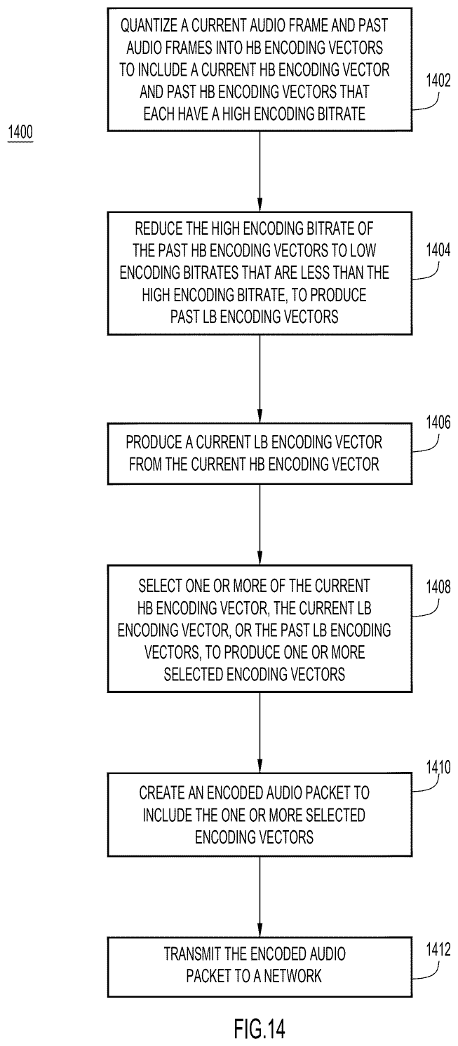

FIG. 14 is a flowchart of an example method 1400 of encoding audio performed by MB encoder 102.

At 1402, MB encoder 102 receives a sequence of audio frames and quantizes a current audio frame and past audio frames of the sequence into HB encoding vectors to include a current HB encoding vector and past HB encoding vectors that each have a high encoding bitrate. For example, MB encoder 102 performs vector quantization of (i.e., vector quantizes) each audio frame into a corresponding HB encoding vector that includes q codeword indices representative of the high encoding bitrate.

At 1404, MB encoder 102 reduces the high encoding bitrate of the past HB encoding vectors to low encoding bitrates that are less than the high encoding bitrate, to produce past LB encoding vectors that have the low encoding bitrates. For example, MB encoder 102 reduces the number q of codeword indices in the past HB encoding vectors to less than q codeword indices (e.g., to m<q codeword indices) representative of the low encoding bitrates. In an example, the low encoding bitrates vary across the past LB encoding vectors. The low encoding bitrates may decrease as time offsets increase between the current HB encoding vector and the past LB encoding vectors. In another example, the low encoding bit rates are equal to each other (i.e., constant).

At 1406, MB encoder 102 produces a current LB encoding vector from the current HB encoding vector and that has a low encoding bitrate that is less than the high encoding bitrate.

At 1408, MB encoder 102 selects one or more of the current HB encoding vector, the current LB encoding vector, or the past LB encoding vectors, to produce one or more selected encoding vectors. In an example, MB encoder 102 selects MB encoding vectors.

At 1410, MB encoder 102 creates an encoded audio packet to include the one or more selected encoding vectors and a header. The encoded audio packet may be an MB packet, an LB packet, or an HB packet.

At 1412, MB encoder 102 transmits the encoded audio packet to a network.

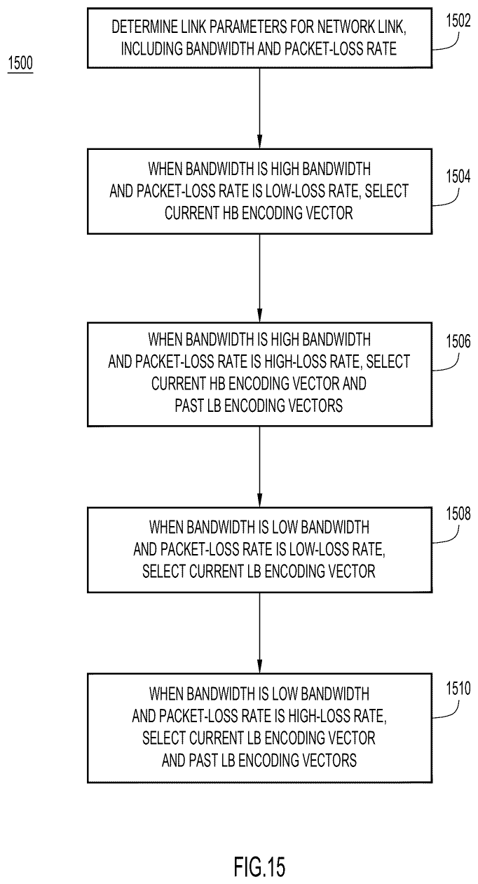

FIG. 15 is a flowchart of an example method 1500 expanding on method 1400.

At 1502, MB encoder 102 determines link parameters for a network link to be used for transmitting the encoded audio packet. The link parameters include a bandwidth and a packet-loss rate of the network link, for example.

In next operations 1504-1510, MB encoder 102 selects different combinations of encoding vectors based on (i.e., according to) the link parameters.

When the bandwidth is the high bandwidth and the packet-loss rate is the low-loss rate, at 1504, MB encoder 102 selects only the current high-bitrate encoding vector, for example.

When the bandwidth is the high bandwidth and the packet-loss rate is the high-loss rate, at 1506, MB encoder 102 selects only the current high-bitrate encoding vector and the past low-bitrate encoding vectors, for example.

When the bandwidth is the low bandwidth and the packet-loss rate is the low-loss rate, at 1508, MB encoder 102 selects only the current low-bitrate encoding vector, for example.

When the bandwidth is the low bandwidth and the packet-loss rate is the high-loss rate, at 1510, MB encoder 102 selects only the current low-bitrate encoding vector and the past low-bitrate encoding vectors, for example.

In an example in which the link parameters include a packet-loss burst length, MB encoder 102 may increase or decrease the selected number of past LB encoding vectors in correspondence with an increase or decrease with the packet-loss burst length, respectively.

In an embodiment, MB encoder 102 may independently encrypt the following encoding vector components (i) the current high-bitrate encoding vector to produce an encrypted current high-bitrate encoding vector, (ii) the current low-bitrate encoding vector to produce an encrypted current low-bitrate encoding vector, and (iii) the past low-bitrate encoding vectors to produce encrypted past low-bitrate encoding vectors. Then, MB encoder 102 may select the encrypted encoding vectors components such that the MB encoder creates an encoded audio packet to include the independently encrypted encoding vector components.

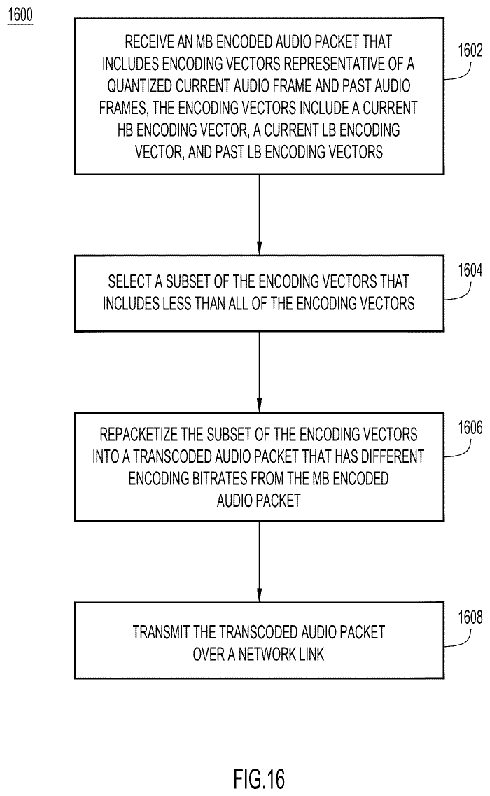

FIG. 16 is a flowchart of an example method 1600 of transcoding (i.e., repacketizing) an encoding audio packet into a transcoded audio packet performed by audio transcoder 104.

At 1602, audio transcoder 104 receives from a network a mixed-bitrate encoded audio packet that includes encoding vectors representative of quantized audio frames including a quantized current audio frame and quantized past audio frames. The encoding vectors may include (i) a current high-bitrate encoding vector (for the quantized current audio frame) having a high encoding bitrate, (ii) a current low-bitrate encoding vector (for the quantized current audio frame) having a low encoding bitrate that is less than the high encoding bitrate, and (iii) past low-bitrate encoding vectors (for the past quantized audio frames) having low encoding bitrates that are less than the high encoding bitrate. The different components (i), (ii), and (iii) of encoding vectors may have been independently encrypted at an MB encoder.

At 1604, audio transcoder 104 selects a subset of the encoding vectors that includes less than all of the encoding vectors.

At 1606, audio transcoder 104 repacketizes the subset of the encoding vectors into a transcoded audio packet that has different encoding bitrates from the mixed-bitrate encoded audio packet.

At 1608, audio transcoder 104 transmits the transcoded audio packet over a network link.

Similar to the operations of methods 1500 and 1600 performed by MB encoder 102, audio transcoder 104 determines link parameters for the network link, and selects different combinations of the encoding vectors for the subset based on the link parameters.

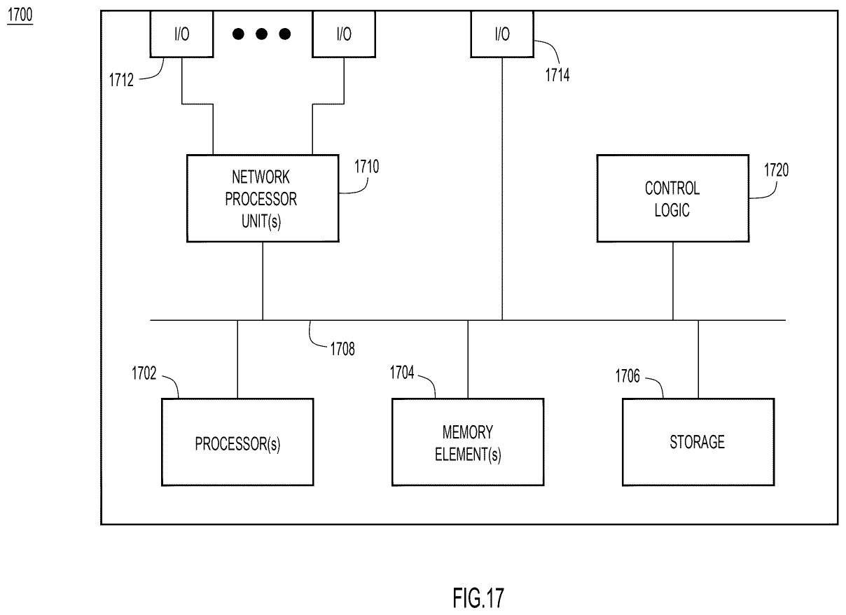

Referring to FIG. 17, FIG. 17 illustrates a hardware block diagram of a computing device 1700 that may perform functions associated with operations discussed herein in connection with the techniques depicted in FIGS. 1-16. In various embodiments, a computing device or apparatus, such as computing device 1700 or any combination of computing devices 1700, may be configured as any entity/entities as discussed for the techniques depicted in connection with FIGS. 1-16 in order to perform operations of the various techniques discussed herein. For example, computing device 1700 may represent audio encoders including MB encoder 102, audio transcoder 104, audio decoders including audio decoder 106, and client/endpoint devices.

In at least one embodiment, the computing device 1700 may be any apparatus that may include one or more processor(s) 1702, one or more memory element(s) 1704, storage 1706, a bus 1708, one or more network processor unit(s) 1710 interconnected with (e.g., coupled to) one or more network input/output (I/O) interface(s) 1712, one or more I/O interface(s) 1714, and control logic 1720. In various embodiments, instructions associated with logic for computing device 1700 can overlap in any manner and are not limited to the specific allocation of instructions and/or operations described herein.

In at least one embodiment, processor(s) 1702 is/are at least one hardware processor configured to execute various tasks, operations and/or functions for computing device 1700 as described herein according to software and/or instructions configured for computing device 1700. Processor(s) 1702 (e.g., a hardware processor) can execute any type of instructions associated with data to achieve the operations detailed herein. In one example, processor(s) 1702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1704 and/or storage 1706 is/are configured to store data, information, software, and/or instructions associated with computing device 1700, and/or logic configured for memory element(s) 1704 and/or storage 1706. For example, any logic described herein (e.g., control logic 1720) can, in various embodiments, be stored for computing device 1700 using any combination of memory element(s) 1704 and/or storage 1706. Note that in some embodiments, storage 1706 can be consolidated with memory element(s) 1704 (or vice versa), or can overlap/exist in any other suitable manner.

In at least one embodiment, bus 1708 can be configured as an interface that enables one or more elements of computing device 1700 to communicate in order to exchange information and/or data. Bus 1708 can be implemented with any architecture designed for passing control, data and/or information between processors, memory elements/storage, peripheral devices, and/or any other hardware and/or software components that may be configured for computing device 1700. In at least one embodiment, bus 1708 may be implemented as a fast kernel-hosted interconnect, potentially using shared memory between processes (e.g., logic), which can enable efficient communication paths between the processes.

In various embodiments, network processor unit(s) 1710 may enable communication between computing device 1700 and other systems, entities, etc., via network I/O interface(s) 1712 (wired and/or wireless) to facilitate operations discussed for various embodiments described herein. In various embodiments, network processor unit(s) 1710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1700 and other systems, entities, etc. to facilitate operations for various embodiments described herein. In various embodiments, network I/O interface(s) 1712 can be configured as one or more Ethernet port(s), Fibre Channel ports, any other I/O port(s), and/or antenna(s)/antenna array(s) now known or hereafter developed. Thus, the network processor unit(s) 1710 and/or network I/O interface(s) 1712 may include suitable interfaces for receiving, transmitting, and/or otherwise communicating data and/or information in a network environment.

I/O interface(s) 1714 allow for input and output of data and/or information with other entities that may be connected to computing device 1700. For example, I/O interface(s) 1714 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1720 can include instructions that, when executed, cause processor(s) 1702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1704 and/or storage 1706 can store data, software, code, instructions (e.g., processor instructions), logic, parameters, combinations thereof, and/or the like used for operations described herein. This includes memory element(s) 1704 and/or storage 1706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In some aspects, the techniques described herein relate to a method including: receiving a mixed-bitrate encoded audio packet that includes encoding vectors representative of a quantized current audio frame and quantized past audio frames, wherein the encoding vectors include a current high-bitrate encoding vector having a high encoding bitrate and past low-bitrate encoding vectors having low encoding bitrates that are less than the high encoding bitrate; selecting a subset of the encoding vectors; repacketizing the subset of the encoding vectors into a transcoded audio packet that has different encoding bitrates from the mixed-bitrate encoded audio packet; and transmitting the transcoded audio packet over a network link.

In some aspects, the techniques described herein relate to a method, wherein: receiving includes receiving the mixed-bitrate encoded audio packet to further include a current low-bitrate encoding vector having a low encoding bitrate that is less than the high encoding bitrate.

In some aspects, the techniques described herein relate to a method, wherein: the current high-bitrate encoding vector includes q codeword indices representative of the high encoding bitrate, and the past low-bitrate encoding vectors each includes less than q codeword indices representative of the low encoding bitrates.

In some aspects, the techniques described herein relate to a method, wherein: the low encoding bitrates of the past low-bitrate encoding vectors vary across the past low-bitrate encoding vectors.

In some aspects, the techniques described herein relate to a method, wherein: the low encoding bitrates decrease as time offsets increase between the current high-bitrate encoding vector and the past low-bitrate encoding vectors.

In some aspects, the techniques described herein relate to a method, further including: determining link parameters for the network link, wherein selecting includes selecting the subset according to/based on the link parameters.

In some aspects, the techniques described herein relate to a method, wherein: the link parameters indicate a bandwidth and a packet-loss rate; and selecting includes selecting the subset based on the bandwidth and the packet-loss rate.

In some aspects, the techniques described herein relate to a method, wherein: the link parameters indicate whether the bandwidth is a high bandwidth or a low bandwidth and the packet-loss rate is a high-loss rate or a low-loss rate; and selecting includes selecting the subset based on whether the bandwidth is the high bandwidth or the low bandwidth and whether the packet-loss rate is the high-loss rate or the low-loss rate.

In some aspects, the techniques described herein relate to a method, wherein: when the bandwidth is the high bandwidth and the packet-loss rate is the low-loss rate, selecting includes selecting the current high-bitrate encoding vector; and when the bandwidth is the high bandwidth and the packet-loss rate is the high-loss rate, selecting includes selecting the current high-bitrate encoding vector and the past low-bitrate encoding vectors.

In some aspects, the techniques described herein relate to a method, wherein: the mixed-bitrate encoded audio packet further includes a current low-bitrate encoding vector having a low encoding bitrate that is less than the high encoding bitrate; when the bandwidth is the low bandwidth and the packet-loss rate is the low-loss rate, selecting includes selecting the current low-bitrate encoding vector; and when the bandwidth is the low bandwidth and the packet-loss rate is the high-loss rate, selecting includes selecting the current low-bitrate encoding vector and the past low-bitrate encoding vectors.

In some aspects, the techniques described herein relate to a method, wherein: the link parameters indicate a packet-loss burst length; and selecting increases or decreases a number of the encoding vectors in the subset in correspondence with increases or decreases in the packet-loss burst length.

In some aspects, the techniques described herein relate to an apparatus including: a network interface unit to communicate with a network; and a processor coupled to the network interface unit and configured to perform: receiving a mixed-bitrate encoded audio packet that includes encoding vectors representative of a quantized current audio frame and quantized past audio frames, wherein the encoding vectors include a current high-bitrate encoding vector having a high encoding bitrate and past low-bitrate encoding vectors having low encoding bitrates that are less than the high encoding bitrate; selecting a subset of the encoding vectors; repacketizing the subset of the encoding vectors into a transcoded audio packet that has different encoding bitrates from the mixed-bitrate encoded audio packet; and transmitting the transcoded audio packet over a network link.

In some aspects, the techniques described herein relate to an apparatus, wherein: receiving includes receiving the mixed-bitrate encoded audio packet to further include a current low-bitrate encoding vector having a low encoding bitrate that is less than the high encoding bitrate.

In some aspects, the techniques described herein relate to an apparatus, wherein: the current high-bitrate encoding vector includes q codeword indices representative of the high encoding bitrate, and the past low-bitrate encoding vectors each includes less than q codeword indices representative of the low encoding bitrates.

In some aspects, the techniques described herein relate to an apparatus, wherein: the low encoding bitrates of the past low-bitrate encoding vectors vary across the past low-bitrate encoding vectors.

In some aspects, the techniques described herein relate to an apparatus, wherein: the low encoding bitrates decrease as time offsets increase between the current high-bitrate encoding vector and the past low-bitrate encoding vectors.

In some aspects, the techniques described herein relate to an apparatus, further including: determining link parameters for the network link, wherein selecting includes selecting the subset according to the link parameters.

In some aspects, the techniques described herein relate to a non-transitory computer readable medium encoded with instructions that, when executed by a processor, cause the processor to perform: receiving a mixed-bitrate encoded audio packet that includes encoding vectors representative of a quantized current audio frame and quantized past audio frames, wherein the encoding vectors include a current high-bitrate encoding vector having a high encoding bitrate and past low-bitrate encoding vectors having low encoding bitrates that are less than the high encoding bitrate; selecting a subset of the encoding vectors; repacketizing the subset of the encoding vectors into a transcoded audio packet that has different encoding bitrates from the mixed-bitrate encoded audio packet; and transmitting the transcoded audio packet over a network link.

In some aspects, the techniques described herein relate to a non-transitory computer readable medium, wherein: the instructions to cause the processor to perform receiving include instructions to cause the processor to perform receiving the mixed-bitrate encoded audio packet to further include a current low-bitrate encoding vector having a low encoding bitrate that is less than the high encoding bitrate.

In some aspects, the techniques described herein relate to a non-transitory computer readable medium, wherein: the current high-bitrate encoding vector includes q codeword indices representative of the high encoding bitrate, and the past low-bitrate encoding vectors each includes less than q codeword indices representative of the low encoding bitrates.

In some aspects, the techniques described herein relate to a method including: quantizing a current audio frame and past audio frames into high-bitrate encoding vectors to include a current high-bitrate encoding vector and past high-bitrate encoding vectors that each have a high encoding bitrate; reducing the high encoding bitrate of the past high-bitrate encoding vectors to low encoding bitrates that are less than the high encoding bitrate, to produce past low-bitrate encoding vectors that have the low encoding bitrates; selecting one or more of the current high-bitrate encoding vector or the past low-bitrate encoding vectors, to produce one or more selected encoding vectors; creating an encoded audio packet to include the one or more selected encoding vectors; and transmitting the encoded audio packet to a network.

In some aspects, the techniques described herein relate to a method, wherein: quantizing includes quantizing such that the high-bitrate encoding vectors include q codeword indices representative of the high encoding bitrate; and reducing includes reducing the q codeword indices to less than q codeword indices representative of the low encoding bitrates.

In some aspects, the techniques described herein relate to a method, wherein: reducing includes reducing the low encoding bitrates such that the low encoding bitrates vary across the past low-bitrate encoding vectors.

In some aspects, the techniques described herein relate to a method, wherein: reducing further includes reducing the low encoding bitrates such that the low encoding bitrates decrease as time offsets increase between the current high-bitrate encoding vector and the past low-bitrate encoding vectors.

In some aspects, the techniques described herein relate to a method, wherein: selecting includes selecting mixed-bitrate encoding vectors to include the current high-bitrate encoding vector and the past low-bitrate encoding vectors.

In some aspects, the techniques described herein relate to a method, further including: producing, from the current high-bitrate encoding vector, a current low-bitrate encoding vector that has a low encoding bitrate that is less than the high encoding bitrate, wherein selecting includes selecting mixed-bitrate encoding vectors to include the current high-bitrate encoding vector, the current low-bitrate encoding vector, and the past low-bitrate encoding vectors.

In some aspects, the techniques described herein relate to a method, further including: determining link parameters for a network link to be used for transmitting the encoded audio packet, wherein selecting includes selecting one or more of the current high-bitrate encoding vector or the past low-bitrate encoding vectors according to the link parameters.

In some aspects, the techniques described herein relate to a method, wherein: the link parameters indicate a bandwidth and a packet-loss rate; and selecting includes selecting one or more of the current high-bitrate encoding vector or the past low-bitrate encoding vectors based on the bandwidth and the packet-loss rate.

In some aspects, the techniques described herein relate to a method, wherein: the link parameters indicate whether the bandwidth is a high bandwidth or a low bandwidth and the packet-loss rate is a high-loss rate or a low-loss rate; and selecting includes selecting one or more encoding vectors based on whether the bandwidth is the high bandwidth or the low bandwidth and whether the packet-loss rate is the high-loss rate or the low-loss rate.

In some aspects, the techniques described herein relate to a method, wherein: when the bandwidth is the high bandwidth and the packet-loss rate is the low-loss rate, selecting includes selecting the current high-bitrate encoding vector; and when the bandwidth is the high bandwidth and the packet-loss rate is the high-loss rate, selecting includes selecting the current high-bitrate encoding vector and the past low-bitrate encoding vectors.

In some aspects, the techniques described herein relate to a method, further including: producing, from the current high-bitrate encoding vector, a current low-bitrate encoding vector that has a low encoding bitrate that is less than the high encoding bitrate, and wherein, when the bandwidth is the low bandwidth and the packet-loss rate is the low-loss rate, selecting includes selecting the current low-bitrate encoding vector, wherein when the bandwidth is the low bandwidth and the packet-loss rate is the high-loss rate, selecting includes selecting the current low-bitrate encoding vector and the past low-bitrate encoding vectors.

In some aspects, the techniques described herein relate to a method, wherein: the link parameters indicate a packet-loss burst length; and selecting increases or decreases a number of the past low-bitrate encoding vectors in correspondence with increases or decreases in the packet-loss burst length.

In some aspects, the techniques described herein relate to a method, further including: encrypting the current high-bitrate encoding vector to produce an encrypted current high-bitrate encoding vector; and encrypting the past low-bitrate encoding vectors independently of encrypting the current high-bitrate encoding vector to produce encrypted past low-bitrate encoding vectors, wherein selecting includes selecting to include the encrypted current high-bitrate encoding vector and the encrypted past low-bitrate encoding vectors.

In some aspects, the techniques described herein relate to an apparatus including: a network interface unit to communicate with a network; and a processor coupled to the network interface unit and configured to perform: quantizing a current audio frame and past audio frames into high-bitrate encoding vectors to include a current high-bitrate encoding vector and past high-bitrate encoding vectors that each have a high encoding bitrate; reducing the high encoding bitrate of the past high-bitrate encoding vectors to low encoding bitrates that are less than the high encoding bitrate, to produce past low-bitrate encoding vectors that have the low encoding bitrates; selecting one or more of the current high-bitrate encoding vector or the past low-bitrate encoding vectors, to produce one or more selected encoding vectors; creating an encoded audio packet to include the one or more selected encoding vectors; and transmitting the encoded audio packet to a network.

In some aspects, the techniques described herein relate to an apparatus, wherein the processor is configured to perform: quantizing by quantizing such that the high-bitrate encoding vectors include q codeword indices representative of the high encoding bitrate; and reducing by reducing the q codeword indices to less than q codeword indices representative of the low encoding bitrates.

In some aspects, the techniques described herein relate to an apparatus, wherein the processor is configured to perform: reducing by reducing the low encoding bitrates such that the low encoding bitrates vary across the past low-bitrate encoding vectors.

In some aspects, the techniques described herein relate to an apparatus, wherein the processor is configured to perform: reducing by reducing the low encoding bitrates such that the low encoding bitrates decrease as time offsets increase between the current high-bitrate encoding vector and the past low-bitrate encoding vectors.

In some aspects, the techniques described herein relate to a non-transitory computer readable medium encoded with instructions that, when executed by a processor, cause the processor to perform: quantizing a current audio frame and past audio frames into high-bitrate encoding vectors to include a current high-bitrate encoding vector and past high-bitrate encoding vectors that each have a high encoding bitrate; reducing the high encoding bitrate of the past high-bitrate encoding vectors to low encoding bitrates that are less than the high encoding bitrate, to produce past low-bitrate encoding vectors that have the low encoding bitrates; selecting one or more of the current high-bitrate encoding vector or the past low-bitrate encoding vectors, to produce one or more selected encoding vectors; creating an encoded audio packet to include the one or more selected encoding vectors; and transmitting the encoded audio packet to a network.

In some aspects, the techniques described herein relate to a non-transitory computer readable medium, wherein: the instructions to cause the processor to perform quantizing include instructions to cause the processor to perform quantizing such that the high-bitrate encoding vectors include q codeword indices representative of the high encoding bitrate; and the instructions to cause the processor to perform reducing include instructions to cause the processor to perform reducing the q codeword indices to less than q codeword indices representative of the low encoding bitrates.

In some aspects, the techniques described herein relate to a non-transitory computer readable medium, wherein: the instructions to cause the processor to perform reducing include instructions to cause the processor to perform reducing the low encoding bitrates such that the low encoding bitrates vary across the past low-bitrate encoding vectors.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving a mixed-bitrate encoded audio packet that includes encoding vectors representative of a quantized current audio frame and quantized past audio frames, wherein the encoding vectors include a current high-bitrate encoding vector having a high encoding bitrate and past low-bitrate encoding vectors having low encoding bitrates that are less than the high encoding bitrate;
selecting a subset of the encoding vectors;
repacketizing the subset of the encoding vectors into a transcoded audio packet that has different encoding bitrates from the mixed-bitrate encoded audio packet; and
transmitting the transcoded audio packet over a network link.

2. The method of claim 1, wherein:
receiving includes receiving the mixed-bitrate encoded audio packet to further include a current low-bitrate encoding vector having a low encoding bitrate that is less than the high encoding bitrate.

3. The method of claim 1, wherein:
the current high-bitrate encoding vector includes q codeword indices representative of the high encoding bitrate, and the past low-bitrate encoding vectors each includes less than q codeword indices representative of the low encoding bitrates.

4. The method of claim 1, wherein:
the low encoding bitrates of the past low-bitrate encoding vectors vary across the past low-bitrate encoding vectors.

5. The method of claim 4, wherein:
the low encoding bitrates decrease as time offsets increase between the current high-bitrate encoding vector and the past low-bitrate encoding vectors.

6. The method of claim 1, further comprising:
determining link parameters for the network link,
wherein selecting includes selecting the subset based on the link parameters.

7. The method of claim 6, wherein:
the link parameters indicate a bandwidth and a packet-loss rate; and
selecting includes selecting the subset based on the bandwidth and the packet-loss rate.

8. The method of claim 7, wherein:
the link parameters indicate whether the bandwidth is a high bandwidth or a low bandwidth and the packet-loss rate is a high-loss rate or a low-loss rate; and
selecting includes selecting the subset based on whether the bandwidth is the high bandwidth or the low bandwidth and whether the packet-loss rate is the high-loss rate or the low-loss rate.

9. The method of claim 8, wherein:
when the bandwidth is the high bandwidth and the packet-loss rate is the low-loss rate, selecting includes selecting the current high-bitrate encoding vector; and
when the bandwidth is the high bandwidth and the packet-loss rate is the high-loss rate, selecting includes selecting the current high-bitrate encoding vector and the past low-bitrate encoding vectors.

10. The method of claim 8, wherein:
the mixed-bitrate encoded audio packet further includes a current low-bitrate encoding vector having a low encoding bitrate that is less than the high encoding bitrate;
when the bandwidth is the low bandwidth and the packet-loss rate is the low-loss rate, selecting includes selecting the current low-bitrate encoding vector; and
when the bandwidth is the low bandwidth and the packet-loss rate is the high-loss rate, selecting includes selecting the current low-bitrate encoding vector and the past low-bitrate encoding vectors.

11. The method of claim 6, wherein:
the link parameters indicate a packet-loss burst length; and
selecting increases or decreases a number of the encoding vectors in the subset in correspondence with increases or decreases in the packet-loss burst length.

12. An apparatus comprising:
a network interface unit to communicate with a network; and
a processor coupled to the network interface unit and configured to perform:
receiving a mixed-bitrate encoded audio packet that includes encoding vectors representative of a quantized current audio frame and quantized past audio frames, wherein the encoding vectors include a current high-bitrate encoding vector having a high encoding bitrate and past low-bitrate encoding vectors having low encoding bitrates that are less than the high encoding bitrate;
selecting a subset of the encoding vectors;
repacketizing the subset of the encoding vectors into a transcoded audio packet that has different encoding bitrates from the mixed-bitrate encoded audio packet; and
transmitting the transcoded audio packet over a network link.

13. The apparatus of claim 12, wherein:
receiving includes receiving the mixed-bitrate encoded audio packet to further include a current low-bitrate encoding vector having a low encoding bitrate that is less than the high encoding bitrate.

14. The apparatus of claim 12, wherein:
the current high-bitrate encoding vector includes q codeword indices representative of the high encoding bitrate, and the past low-bitrate encoding vectors each includes less than q codeword indices representative of the low encoding bitrates.

15. The apparatus of claim 12, wherein:
the low encoding bitrates of the past low-bitrate encoding vectors vary across the past low-bitrate encoding vectors.

16. The apparatus of claim 15, wherein:
the low encoding bitrates decrease as time offsets increase between the current high-bitrate encoding vector and the past low-bitrate encoding vectors.

17. The apparatus of claim 12, further comprising:
determining link parameters for the network link,
wherein selecting includes selecting the subset based on the link parameters.

18. A non-transitory computer readable medium encoded with instructions that, when executed by a processor, cause the processor to perform:
receiving a mixed-bitrate encoded audio packet that includes encoding vectors representative of a quantized current audio frame and quantized past audio frames, wherein the encoding vectors include a current high-bitrate encoding vector having a high encoding bitrate and past low-bitrate encoding vectors having low encoding bitrates that are less than the high encoding bitrate;
selecting a subset of the encoding vectors;
repacketizing the subset of the encoding vectors into a transcoded audio packet that has different encoding bitrates from the mixed-bitrate encoded audio packet; and
transmitting the transcoded audio packet over a network link.

19. The non-transitory computer readable medium of claim 18, wherein:
the instructions to cause the processor to perform receiving include instructions to cause the processor to perform receiving the mixed-bitrate encoded audio packet to further include a current low-bitrate encoding vector having a low encoding bitrate that is less than the high encoding bitrate.

20. The non-transitory computer readable medium of claim 18, wherein:
the current high-bitrate encoding vector includes q codeword indices representative of the high encoding bitrate, and the past low-bitrate encoding vectors each includes less than q codeword indices representative of the low encoding bitrates.
